(19) United States
(12) Patent Application Publication
(10) Pub. No.: US 2017/0266831 A1
(43) Pub. Date: Sep. 21, 2017

(54) SLICED FOOD PORTIONS

(71) Applicant: GEA Food Solutions Germany GmbH

(72) Inventors: Daniel Wachter, Betzigau (DE); Florian Lenzer, Kempten (DE)

(21) Appl. No.: 15/514,944

(22) PCT Filed: Oct. 2, 2015
(86) PCT No.: PCT/EP2015/072822

§ 371 Date: Mar. 28, 2017

(30) Foreign Application Priority Data
Oct. 6, 2014 (DE) 102014220197.7
Nov. 4, 2014 (DE) 102014222477.2

(51) Int. Cl. B26D 3/28; B26D 7/06

(52) U.S. Cl. CPC B26D 3/28; B26D 7/0625

(57) ABSTRACT

The invention relates to a device for slicing one or more food products, in particular sausage, ham and/or cheese, wherein a respective track is provided for each food product, along which the food product is transported in the direction of a moving blade, said blade cutting off food slices from the front end of the food product and configuring said food slices on a storage table to form a portion consisting of a plurality of food slices. The present invention further relates to a method for slicing one or more food products, in particular sausage, ham and/or cheese, into food slices which are configured to form portions.

The present invention relates to a device for slicing one or several food portion(s), in particular sausage, ham and/or cheese, wherein a track is provided in each case for each food product, along which track said food product is conveyed in the direction of a moving blade which cuts off food slices from the front end of the food product and configures said slices or a delivery table to form a portion consisting of several food slices. In addition, the present invention relates to a method for slicing one or several food, product(s), in particular sausage, ham and/or cheese, into food slices which are configured to form portions.

These types of devices or methods are sufficiently disclosed in the prior art. The disadvantage of the devices or methods according to the prior art, however, is that the cross section of the cut-off slice always corresponds to the cross section of the food product.

Consequently, it has been the object of the present invention to provide a method which does not have the disadvantages of the prior art.

The object is achieved with a device for slicing one or several food product(s), in particular sausage, ham and/or cheese, wherein a track is provided in each case for each food product, along which track said food product is conveyed in the direction of a moving blade which cuts off food slices from the front end of the food product and configures said slices on a delivery table to form a portion consisting of several food slices, wherein a further cutting means divides at least some food slices of an already sliced portion.

The statements made regarding said object of the present invention apply equally to the other objects of the present invention and vice versa.

The present invention relates to a device for slicing food products, such as, for example, sausage, ham and/or cheese. Such types of slicing devices are also designated by the person skilled in the art as “slicers” or “high-performance slicers”. Said slicing devices comprise a moving, in particular rotating, cutting blade which cuts off food slices from the front end of a food product. In this case, the cutting blade rotates at up to 1,000 revolutions per minute and more and/or interacts with a cutting edge which is provided, for example, on the front end of a product support and which, together with the blade, defines the cutting plans in which food slices are cut from the food product. A cutting gap, which is to be as small as possible in order to prevent parts of the food product being “hacked off”, is situated between the cutting blade and the cutting strip. However, the cutting gap has to be large enough to ensure that, where possible, the blade does not contact the cutting edge. During slicing, the food product is continually or intermittently conveyed in the direction of the cutting blade. Once a slice has been cut from the respective food product, the cutting blade moves out of engagement with the respective food product in order then to penetrate into the food product once again and to cut off the next food product slice. The forward feed of the respective food product between two cuts determines the thickness of the respectively cut food slice. The cut food slices fail, for example, onto a delivery table on which they are assembled to form portions. The food slices of a portion can be stacked or shingled, for example. As soon as one portion is finished, it is removed from the discharge region of the blade and the slicing of a new portion can start. The slicing device is preferably provided with several tracks, i.e. several food products are sliced, in particular at least in part simultaneously or at least in part sequentially by a blade. For this purpose, the device comprises one specific track for each food product, along which said food product is conveyed in the direction of the blade.

According to the invention, the device comprises a further cutting means which divides at least some food slices of an already sliced portion. As a result, for example, two or four triangular food slices can be created from one rectangular or square food slice or one circular food slice can be divided into semicircles or pie-slice pieces. In addition, arbitrary shapes can be worked, in particular stamped, into the portion with the cutting means. Exemplary shapes are a heart, a bear, a hare, a Christmas tree, etc.

The cutting means is preferably not straight but curved and comprises, in particular, a closed contour which corresponds in a particularly preferred manner to the above-mentioned shapes.

According to a preferred embodiment, the device comprises an ejecting means, for the part which is left over when the corresponding shape is incorporated. The part to be ejected, which is not put into packaging, is disposed of, for example, or supplied for further processing. Said ejecting means, for example, is a conveyor belt and/or a robot arm. Said part to be ejected is preferably raised and then conveyed away. The raising can be performed, for example, with the cutting means or with a means which is preferably arranged thereon, for example by applying negative pressure which connects the part to be ejected reversibly to the cutting means or to the means.

The further cutting means is preferably a blade which is provided in a particularly preferred manner downstream of the delivery table, with reference to the conveying direction of the sliced portions.

The blade and/or the portion is/are preferably acted upon with an electric charge which ensures that the force needed to divide the portion is reduced. A direct current is preferably applied to the blade and/or to the portion. The voltage is preferably 0-100 volts and/or 0-50 amps. It can be applied continuously or in cycles or intermittently.

According to a preferred embodiment, the device according to the invention is provided with several tracks. In a quite preferred runner, each track comprises one further cutting means. Said cutting means is preferably individually drivable in each case. A sensor, which detects the presence of a portion and/or determines the length thereof with reference to the conveying direction, is preferably provided upstream of the cutting means, once again with reference to the conveying direction of the portion. As a result, it can be ensured that the cutting means only becomes active when a portion is present on the respective track. As a result of measuring the length of the portion, the cut to be applied can be provided, in turn, in a positionally accurate manner.

A further object of the present invention is a method for slicing one or several food product(s), in particular sausage, ham and/or cheese, into food slices which are configured to form portions where at least some of the food slices of a portion are divided once again.

The statements made regarding said object of the present invention apply equally to the other objects of the present invention and vice versa.

According to the invention, it is provided in the case of the method that, after they have been sliced, at least some of the food slices of a portion are divided once again.

The food slices of the respective portion are preferably divided with a movement of a putting means at an angle, in particular perpendicular, with respect to their conveying direction. The cutting means is preferably moved up and down in a vertical manner.

The food slices are preferably fixed during cutting, for example by a hold-down device.

According to a particularly preferred embodiment of the present invention, when being divided, the portion rests on a support, for example a conveyor belt. In a particularly preferred manner, the food slice which rests directly on the support is not divided or is not completely divided. In particular, said food slice is only cut into such that the portions which are created as a result of the dividing of a portion are still connected together at least temporarily in the region of the bottommost slice. This facilitates the further conveying of the portions together, for example from the portion-dividing station to the packaging machine and/or the placing of said portions together into packaging.

The non-divided or only cut-into food slice is preferably divided when it is being conveyed by the additional cutting means into the packaging. This can be effected, for example, when being transferred from one conveyor belt to another and/or when the portions are being inserted into the packaging by part of the divided portion being moved relative to the other part and, in this case, the bottommost slice tearing along the perforation and/or the first cut thereof.

The sliced portions are preferably placed into a packet together. As a result, the original shape of the sliced portion, for example a rectangle or a square, is maintained, it being possible, however, for triangular food slices to be removed from the pack.

The invention is explained below by way of the figures. Said explanations are simply as an example and do not restrict the general concept of the invention. The explanations apply equally to all the objects of the present invention.

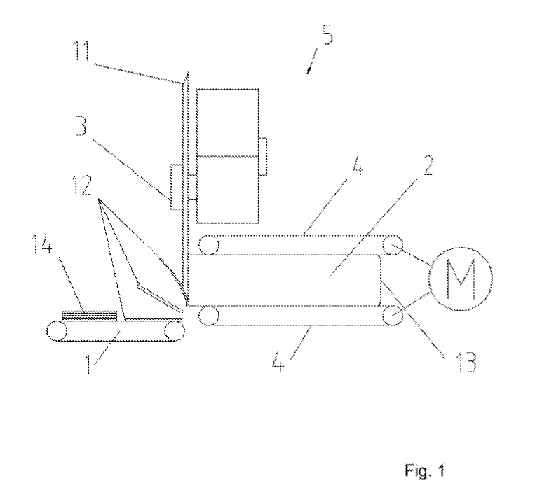

FIG. 1 shows a device according to the prior art.

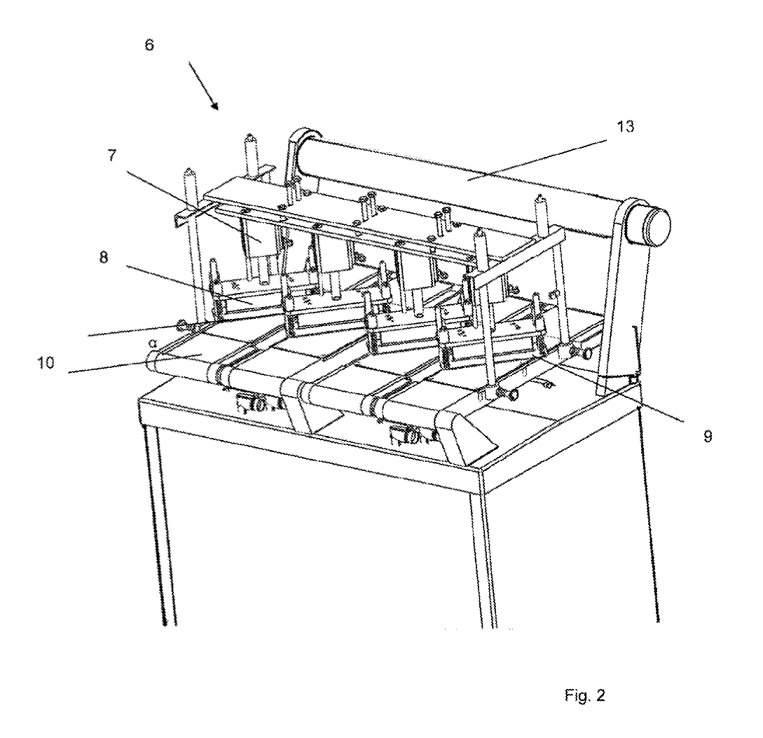

FIG. 2 shows the portion cutter 6.

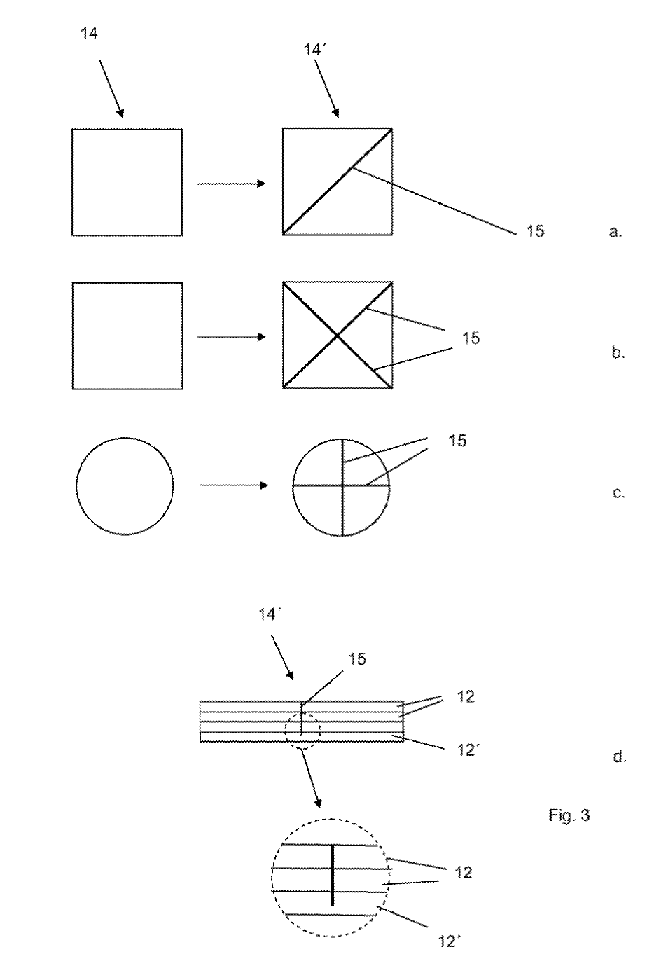

FIG. 3 shows some examples of sliced portions.

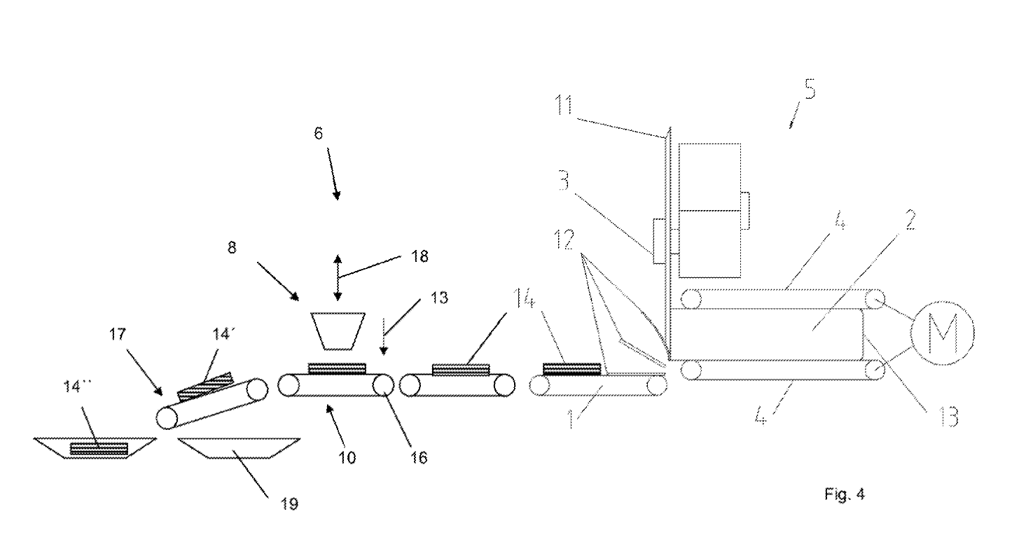

FIG. 4 Shows the device according to the invention.

FIG. 1 shows a slicing device 5 according to the prior art. The slicing device 5 comprises a cutting blade 11 which cuts a food product 2 into food slices 12. To this end, each food product 2 is conveyed in a continuous or intermittent manner in the direction of the cutting plane of the blade 11 by way of a conveying means 4, here two conveyor belts 4. The bottom conveyor belt 4 is at the same time a product support. The cutting blade 11 is fastened on a rotating blade receiving means 3 and interacts in a cutting manner with a cutting edge, which is provided, for example, on the front end of a product support 4, and which together define the cutting plane. Between the blade 11 and the cutting edge there is present a so-called cutting gap which is to be as small as possible, but has to be large enough to ensure that the blade does not contact the cutting edge. Said gap has to be regularly adjusted. This can be effected as a result of a movement of the blade and/or of the cutting edge. In addition, the cutting edge has to be aligned parallel to the blade. Once they have been sliced, the food slices fall, as a rule, onto a delivery table 1 which is provided with conveying means, for example a conveyor or conveyor belt on which they are configured in each case to form a portion 14, here a stack. The finished portions 14 are then conveyed out of the cutting blade region and are then packaged. An alignment plate, which, in particular, prevents too long an elongation of the conveying means, can be provided beneath the conveying means of the delivery table. The slice thickness is produced from the forward feed section of the food product between two cuts. Where the blade rotational speed is constant, the adjustment of the slice thickness is effected by means of the forward feed speed or the food product. The slicing device can comprise, per feed route, a gripper which grips the rear end of the food product 2 prior to or during the slicing process and stabilizes the same during the slicing process, in particular toward the end of the slicing process, and disposes of the end piece which is not able to be sliced. Each gripper is preferably provided on a gripper carriage (not shown) which moves the gripper back and forth, in particular parallel to the forward feed direction of the food product.

The slicing device is preferably provided with several tracts, i.e. several food products 2 are sliced in particular at least temporarily simultaneously or at least temporarily sequentially by a blade. For this purpose, the device comprises one specific track for each food product, along which track said food product is conveyed in the direction of the blade 11.

FIG. 2 shows the portion cutter 6 according to the invention which is provided downstream of the delivery table 4 with reference to the conveying direction of the sliced portions. In the present case, the portion cutter 6 comprises four cutting means 8, here blades, which can cut four sliced portions into two parts at the same time. The portion cutter 6 according to FIG. 4 is consequently provided for a four-track slicing device where four food products are able to be sliced simultaneously. The person skilled in the art understands, however, that more or fewer cutting means 8 can also be present. The sliced portions, which have one or several food slices, are conveyed in each case individually by way of the conveying means 10 into the operating region of the cutting means 8. In this case, they preferably pass a sensor 13 which, is provided upstream of the cutting means 8 with reference to the conveying direction of the portions. Said sensor can establish, on the one hand, the presence on the respective track of a portion to be cut and, on the other hand, according no a preferred embodiment, can determine the length of the respective portion on the respective track. On the basis of said length measurement, the conveying means 10 is then preferably controlled in each case in such a manner that the portion is situated in the desired position relative to the cutting means 8 on each track during the separating cut. The conveying means 10 is preferably stationary during the cutting process. Each cutting means 8 preferably comprises its own drive 7, here a pneumatic cylinder, which drives the cutting means, here along the vertical, and as a result divides at least some food slices of a portion into two or more parts. In the present case, each cutting means is provided with a hold-down device or protection means 9 which is mounted in a resilient manner on the cutting means, here a blade, or on the bearing arrangement thereof. As soon as the hold-down device or protection means touches the portion, it stops substantially in its position and the blade penetrates through the bold-down device or protection means into the portion in order to divide at least some food slices of the portion. As soon as the drive is moved in the opposite direction again and the cutting blade is also no longer in contact with the food slices, the springs are relaxed again and the hold-down device or protection means returns into its original position in which the blade does not project out of the protection means and consequently does not represent any danger to the operating staff. In the present case, the cutting means 8 is provided at an angle α to the conveying direction of the portion and consequently cuts the food slice along a diagonal. The person skilled in the art recognizes that the cutting means is also able to be provided in another manner, in particular that the angle α thereof is adjustable.

FIG. 3 shows scene examples of a portion consisting of several food slices directly after the slicing thereof (left-hand representation) and after the division thereof (right-hand representation). In the case of the example according to FIG. 3a, the food slices with an originally square or rectangular cross section are divided into two portions each with triangular food slices.

In the case of the example according to 3b, a food slice with an originally triangular or square cross section is divided into four portions each with a triangular cross section.

In the case of the example according to FIG. 3c, a circular food slice is quartered, i.e. divided into four portions each with a quadrant-shaped cross section.

FIG. 3d shows a preferred embodiment of the present invention which can apply to all the possible shapes of the division of sliced portions. FIG. 3d shows a portion which in the present case consists of four food slices. Said portion is divided by way of the cut 15 into two or more parts, the cut not extending through all the food slices, but only through the three top slices, i.e. facing the blade 8. The bottommost slice, by way of which the portion rests on a support, is only cut into and/or perforated and is not completely severed, as can be seen, in particular, from the enlargement. As a result, the sliced portions still remain connected together after the cut at least temporarily by the bottommost food slice 12′ when they are conveyed further in the direction of a packaging machine, which facilitates conveying them together and/or placing them together into packaging. The cut-into and/or perforated slice is preferably completely separated, however, when it is being conveyed or when it is placed into the packaging.

FIG. 4 shows the device according to the invention. Once the portions 14 have been sliced and removed out of the discharge region of the blade 11, they move to the portion cutter 6 according to the invention with the cutting means 8. A sensor 13, which, on the one hand, detects whether a portion is situated on the respective track and which, on the other hand, according to a preferred embodiment, measures the length of the respective position whilst it is conveyed along the sensor, which is provided in a stationary manner, is provided upstream of the cutting means 8, which in the present case, as shown by the double arrow 18, is moved along a vertical. The signal of the sensor is used for controlling/regulating the drive of the conveying means 10 in order to move the respective portion into the desired position relative to the cutting means 8. As soon as the respective portion is situated in the respectively desired position, the conveying means 10 is preferably stopped and the cutting movement 18, which divides at least some food slices of the respective portion once again into two or several parts, can be effected by, in the present case, the cutting means 8, here a blade, being moved vertically downward, which is symbolized by the reference symbol 18. After the cut, the cutting means 8 is moved back into its original position again and, at the same time or thereafter, the sliced portions are conveyed in the direction of a packaging machine and are there placed into packaging 19 by means of an inserting means 17.

For the case where not all slices of a portion have been fully severed, the dividing of the, for example, only cut-into food slices 12′ is effected during conveying and/or during the inserting of the portions into the packaging. This can be effected, for example, as a result of part of the sliced portion being moved relative to the other part of the portions and, as a result, a force being exerted onto the cut-into position which results in complete separation of the two parts of the portion. This is preferably not effected, however, until after the sliced portion is forwarded and/or when it is placed into the packaging because the food slice 12′ which is up to now not yet sliced but only cut-into, stabilizes the portions in their position relative to one another.

The person skilled in the art understands that the sliced portions can be placed together into one item of packaging or separately from one another into several items of packaging.

### LIST OF REFERENCES

1 Delivery table

2 Food product

3 Blade receiving moans

4 Support surface, product support, conveyor belt

5 Slicing device

6 Portion cutter

7 Drive

8 Cutting means blade

9 Hold-down device, protection means

10 Support, conveying means, conveyor belt, one conveyor belt per track

11 Blade, cutting blade, circular blade, sickle blade

12 Food slices

12 Bottommost slice of a food portion

13 Sensor

14 Portion, food portion, consisting of several slices

14′ Cut portion, pre-cut portion

14′ Completely sliced portion

15 Cut, division of a sliced portion

16 Drive, controlled drive

17 Inserting means

18 Movement of the blade 8

19 Packaging

1) A device for slicing one or several food product(s), in particular sausage, ham and/or cheese, the device comprising:
a track for each food product, along which the food product is conveyed in a direction of a moving blade that cuts off food slices from a front end of the food product and configures the food slices on a delivery table to form a portion comprising several of the food slices,
wherein the device comprises a cutting means for each track that divides at least some of the food slices of the portion, and
wherein each cutting means is individually drivable.

2) The device as claimed in claim 1, wherein the cutting means is provided downstream of the delivery table so that the division of at least some of the food slides with the cutting means is effected downstream of the delivery table.

3) The device as claimed in claim 1, wherein the device comprises several tracks, and
wherein one food product is sliced on each track, and one cutting means is provided per track.

4) The device as claimed in claim 3, wherein each cutting means is individually drivable.

5) The device as claimed in claim 1, wherein the device comprises a sensor that detects presence of the portion and/or determines a length of the portion with reference to a conveying direction, and
wherein the sensor is provided upstream of the cutting means.

6) A method for slicing one or several food product(s), in particular sausage, ham and/or cheese, into food slices, which are configured to form portions, wherein the method comprises dividing at least some of the food slices of a portion once again,
wherein the portion rests on a support while being divided, and
wherein a food slice that rests on the support is not divided or is not completely divided.

7) The method as claimed in claim 6, wherein the food slices of a respective portion are divided by way of a movement of the cutting means at an angle, in particular perpendicular with respect to their conveying direction.

8) (canceled)

9) The method as claimed in claim 6, wherein the food slice that rests directly on the support, is divided when the portion is forwarded and/or when the portion is inserted into a packaging.

10) The method as claimed in claim 6, wherein method comprises inserting the sliced portions together into a package.

11) The device as claimed in claim 1, wherein the portion rests on a support while being divided, and
wherein a food slice that rests directly on the support is not divided or is not completely divided with the cutting means.

12) The device as claimed in claim 1, wherein the cutting means comprises a hold-down device or protection means, a drive, and a blade,
wherein as soon as the hold-down device or protection means touches the portion, the hold-down device or protection means stops and the drive drives the blade so that the blade penetrates through the hold-down device or protection means into the portion to divide at least some of the food slides of the portion.

13) The device as claimed in claim 12, wherein after the dividing, the drive moves the blade in an opposite direction and the hold-down device or protection means returns its original position such that the blade does not project out of the hold-down device or protection means.

14) The device as claimed in claim 13, wherein the drive is a pneumatic cylinder.

15) The device as claimed in claim 14, wherein the drive drives the blade vertically to penetrate through the hold-down device or protection means.

16) The method as claimed in claim 6, wherein the method comprises:
touching the portion with a hold-down device or protection means of the cutting means; and
driving a blade of the cutting means to penetrate through the hold-down device or protection means and into the portion to divide at least some of the food slides of the portion.

17) The method as claimed in claim 16, wherein the support is stationary during the dividing.

18) The method as claimed in claim 17, wherein after the dividing, the method comprises a step of moving the blade in an opposite direction and then returning the hold-down device or protection means to its original position such that the blade does not project out of the hold-down device or protection means.

19) A device for slicing a food product, the device comprising:
a moving blade;
a track along which the food product is conveyed in a direction of the moving blade, the moving blade cuts off food slices from a front end of the food product and configures the food slices on a delivery table to form a portion comprising several food slices;
a sensor that detects presence of the portion and/or determines a length of the portion, with reference to a conveying direction; and
a cutting means that divides at least some of the food slices of the portion;
wherein the sensor is provided upstream of the cutting means;
wherein the cutting means is individually drivable;
wherein the cutting means is provided downstream of the delivery table so that division of at least some of the food slides with the cutting means is effected downstream of the delivery table;
wherein the portion rests on a support while being divided;
wherein one of the food slices of the portion that rests directly on the support is not divided or is not completely divided;
wherein the cutting means comprises a hold-down device or protection means, a drive, and a blade;
wherein as soon as the hold-down device or protection means touches the portion, the drive drives the blade vertically downward so that the blade penetrates through the hold-down device or protection means into the portion to divide at least some of the food slides of the portion; and
wherein after the dividing, the drive moves the blade vertically upward and the hold-down device or protection means returns its original position such that the blade does not project out of the hold-down device or protection means.

20) The device of claim 19, wherein the support is stationary during the dividing.

21) The device of claim 20, wherein the food slices of a respective portion are divided by way of a movement of the cutting means at an angle, in particular perpendicular with respect to their conveying direction.
